(19) United States
(12) Patent Application Publication
(10) Pub. No.: US 2002/0030646 A1
(43) Pub. Date: Mar. 14, 2002

(54) Highly bright field emission display device

(76) Inventors: Yoon-Ho Song, Taejon (KR); Moon-Youn Jung, Seoul (KR); Seung-Youl Kang, Seoul (KR); Jin-Ho Lee, Taejon (KR); Kyoung-Ik Cho, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/733,700

(22) Filed: Dec. 8, 2000

(30) Foreign Application Priority Data
Dec. 8, 1999 (KR) 1999-55883

(51) Int. Cl. G09G 3/20

(52) U.S. Cl. 345/75.2

(57) ABSTRACT

In the field emission display device in which an electric field emission device is applied to a flat panel display device, an upper plate and a lower plate are vacuum-packaged in parallel, and the lower plate is constructed by row and column signal buses made of metal capable of performing a matrix addressing and by pixels defined by the row and column signal buses, and each pixel is constructed by a film type field emitter, a control device for controlling the film type field emitter and an addressing device for transferring scan and data signals of a display to the control device. Further, the control device is composed of a switching device for directly controlling field emission current of the film type field emitter and a memory device for maintaining the data signal of the display, and the upper plate is made up of anode electrode for accelerating, as high energy, electron emitted from the field emitter, against the field emitter, and a phosphor for performing a cathode luminescence.

### FIELD OF THE INVENTION

The present invention relates to a flat panel display device; and more particularly to a field emission display (ZED) device gotten by applying a field emission device to a flat panel display equipment.

### PRIOR ART OF THE INVENTION

A field emission display device is based on such a structure that a lower plate having a plurality of field emitters and an upper plate having phosphors are vacuum-packaged with a narrow interval of 2 mm or smaller than 2 mm so as to become parallel with each other. In the field emission display device with such structure, electrons emitted from the field emitters of the lower plate collide with the phosphor of the upper plate, to thus produce cathodoluminescence of the phosphor and display a video. At these days, the field emission display device is being increasingly researched as a flat plane display capable of being replaced from a conventional cathode ray tube (CRT).

The field emitter as a kernel constructive device of the lower plate in the field emission display device may be largely different in an efficiency of an electron emission, according to an elemental structure, emitter material and a shape of the emitter. Currently the structure of the field emission device can be largely classified into a diode composed of a cathode or an emitter, and an anode, and a triode composed of a cathode, a gate and an anode. As the material of the emitter, it is mainly used metal, silicon, diamond, diamond like carbon, carbon nanotube etc. The metal and the silicon are generally provided as a triode structure, and the diamond and the carbon nanotube etc. are provided as a diode structure. The diode field emitter is manufactured by forming the diamond or carbon nanotube as a film shape, and is inferior to the triode in an aspect of a control for an electron emission and in a driving aspect of low voltage, but is simple in a manufacture process and is high in a reliability for the electron emission.

The construction of the field emission display device having a conventional diode field emitter is described as follows, referring to FIG. 1.

The lower plate of the field emission display device having the conventional diode field emitter is made up of a first glass substrate 10B, metal electrode 11 arrayed in a belt shape on the first glass substrate 10B, and a film type field emitter 12 formed on the metal electrode 11. The upper plate thereof is composed of a second glass substrate 10T, a transparent electrode 13 arrayed in a belt shape intersected with the metal electrode 11 on the second glass substrate 10T, and a phosphor 14 pattern of red R, green G and blue B formed on the transparent electrode 13. These lower and upper plates are packaged in parallel with a spacer 15 as a support role provided between two plates in such a shape that the film type field emitter 12 and the phosphor 14 are confronted with each other.

In FIG. 1, the metal electrode 11 of the lower plate and the transparent electrode 13 of the upper plate are provided respectively as cathode electrode and anode electrode, and a cross area of two electrodes is defined as one pixel.

In a display driving aspect, meanwhile, in the lower plate of FIG. 1, the film type field emitter 12 is connected to a row signal bus 21R arrayed in Y1, Y2, . . . , Yn as shown in FIG. 2, and in the upper plate of FIG. 1, the phosphor 14 is connected to a column signal bus 31C of X1, X2, . . . , Xn arrayed perpendicularly to the row signal bus as shown in FIG. 3. The row signal bus and the column signal bus may become different according to an alignment direction of the upper and lower plates.

Therefore, as shown in FIGS. 2 and 3, the driving of the display device may be obtained by a matrix shape, and a display signal as addressed to each pixel by the row signal bus of the lower plate and the column signal bus of the upper plate. That is when one row is selected by a row signal, column signals are inputted in sequence or at the same time so that all pixels on that row are addressed, and subsequently, signals on a next row are inputted sequentially or crossly. Electric field necessary for an electron emission is decided by voltage difference of the row signal bus and the column signal bus, and in general, the electron emission occurs in the field emitter when the electric field over 1 V/μm is applied to the field emitter material.

The diode field emitter used in the conventional field emission display device shown in FIGS. 1 through 3 does not require a gate and a gate insulation film, differently from the triode field emitter based on a cone shape, thus, its structure is simple and its manufacture process is easy. Further, not only the diode field emitter has very high reliability in device since a breakdown probability of the field emitter through a sputtering effect in the electron emission is very low, but also there is never a breakdown phenomenon of a gate insulation body and the gate which becomes a serious problem in the triode field emitter.

However, in the field emission display device having an installment of the diode field emitter, high electric field necessary for the electron emission should be applied between electrodes of the upper plate and the lower plate which are gapped with each other by a considerable interval of about 200 μm through 2 mm, namely for instance, between the metal electrode 11 and the transparent electrode 13 of FIG. 1, therefore a high voltage display signal is needed and according to that, a high voltage driving circuit based on a high cost is required.

Especially, in the field emission display device having the diode field emitter, the interval between the upper and lower plates can be reduced so as to decrease voltage. necessary for the electron emission, but voltage over 200 V must be applied to an anode electrode since high energy electron over 200 eV is needed to emit the light from the phosphors in the field emission display device. In other words, it is scarcely valid a low voltage driving in the conventional structure that the anode electrode such as the transparent electrode 13 of FIG. 1 and the column signal bus 31C of FIG. 3 etc. is used as a signal bus of the display and simultaneously as acceleration electrode of electron.

Furthermore, the diode field emitter is mainly constructed as a thin film type, thus an electron emission characteristic is very unstable and its uniformity is poor.

In the conventional diode field emission display, meanwhile, the bigger a display screen becomes and the higher the display screen becomes in resolution, the shorter a scan time of a display signal becomes, to thus drop a luminescence and seriously cause a cross-talk of the display signal.

### SUMMARY OF THE INVENTION

Therefore, it is an object of the present invention to provide a bright field emission display device in which a low voltage driving is valid by separating a signal bus of a display from acceleration electrode of electron, an electron emission characteristic is stable and its uniformity and reliability can be improved, and a cross-talk of a display signal can be prevented.

In accordance with the present invention for achieving the above object, a field emission display device in which an upper plate and a lower plate are vacuum-packaged so as to become parallel with each other, comprises a first transparent substrate as the upper plate; transparent electrode formed on the first transparent substrate, for leading an emission and an acceleration of electron; a phosphor pattern formed on the transparent electrode; a second transparent substrate as the lower plate; a row signal bus and a column signal bus formed so as to be intersected with each other on the second transparent substrate, for defining a pixel; a film type field emitter positioned within the pixel and confronted with the phosphor pattern; a control unit connected to the film type field emitter, for controlling field emission current; and an addressing unit connected with the control unit and the row and column signal buses, for transferring scan and data signals of the display to the control unit.

The inventive field emission display device includes the upper plate which is composed of a first glass substrate, transparent electrode formed on the first glass substrate and a phosphor pattern of red R, green G and blue B formed on the transparent electrode. The field emission display device also includes the lower plate which is composed of a second glass substrate, a row signal bus and a column signal bus of a belt shape formed in cross with each other on the second glass substrate to thus get a pixel so as to gain a matrix addressing, a film type field emitter positioned within the pixel, a control device connected to the film type field emitter, for controlling field emission current, and an addressing device connected with the control device, the row signal bus and the column signal bus, for transferring a scan of a display and a data signal to the control device.

The control device is made up of a semiconductor switching device for directly controlling field emission current of the film type field emitter, and a memory device for maintaining a data signal of the display.

The upper plate and the lower plate are packaged in vacuum so that the film type field emitter and the phosphor of the upper and lower plates may be confronted in parallel with each other through a spacer provided as a supporter.

The inventive field emission display is driven by the following method. That is, high voltage is applied to the upper plate transparent electrode provided as an anode of a panel in which the upper plate and the lower plate are packaged in vacuum, to thereby lead an electron emission from the film type field emitter of the lower plate and simultaneously accelerate the emitted electron as high energy. And then, when a scan and a data signal of the display is inputted to the control device through the addressing device of each pixel connected with the row signal bus and the column signal bus of the lower plate, the control device controls a quantity of electron emitted from the film type field emitter, to thereby represent a matrix video. At this time, the already inputted data signal is stored at a memory portion of the control device, to continuously lead a field emission till its next signal comes.

Accordingly, average emission current from the given field emitter can be largely increased, to largely heighten a brightness of the display. A gray representation of the display is performed by changing voltage amplitude of tho data signal. The inventive active matrix field emission display device can be driven by low voltage, differently from a conventional simple matrix type, and in addition, the brightness of the display can be increased largely.

### BRIEF DESCRIPTION OF THE DRAWINGS

The above and other objects and features of the instant invention will become apparent from the following description of preferred embodiments taken in conjunction with the accompanying drawings, in which:

FIG. 1 is a schematic view showing upper and lower plates of a field emission display device having a conventional diode field emitter;

FIG. 2 indicates a schematic view showing the construction for a lower plate of a field emission display device having the conventional diode field emitter;

FIG. 3 depicts a schematic view showing the construction for an upper plate of a field emission display device having the conventional diode field emitter;

FIG. 4 sets forth a schematic view showing the construction for a lower plate of a field emission display device in a first embodiment of the present invention;

FIG. 5 is a circuit diagram showing the construction of a control device and an addressing device for a lower plate pixel of a field emission display device in a second embodiment of the present invention;

FIG. 6 illustrates a circuit diagram showing the construction of a control device and an addressing device for a lower plate pixel of a field emission display device in a third embodiment of the present invention;

FIG. 7 provides a circuit diagram showing the construction of a control device and an addressing device for a lower plate pixel of a field emission display device in a fourth embodiment of the present invention;

FIG. 8 is a circuit diagram showing the construction of a control device and an addressing device for a lower plate pixel of a field emission display device in a fifth embodiment of the present invention;

FIG. 9 is a sectional view providing a state that the circuit diagram of FIG. 8 is embodied on the basis of the sixth embodiment of the invention; and

FIG. 10 is a sectional view showing a state that the circuit diagram of FIG. 8 is embodied on the basis of the seventh embodiment of the invention.

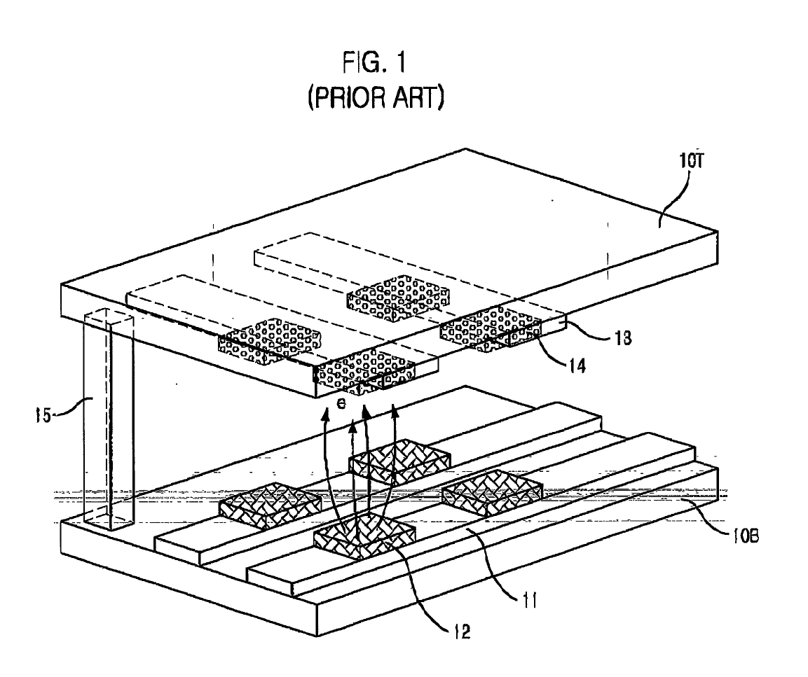

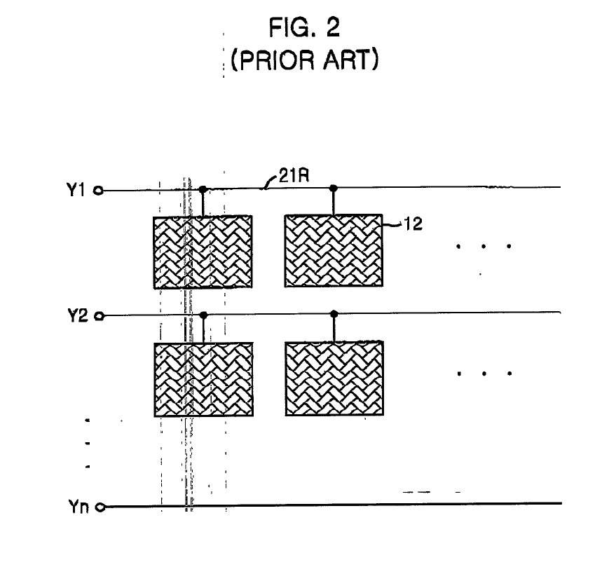

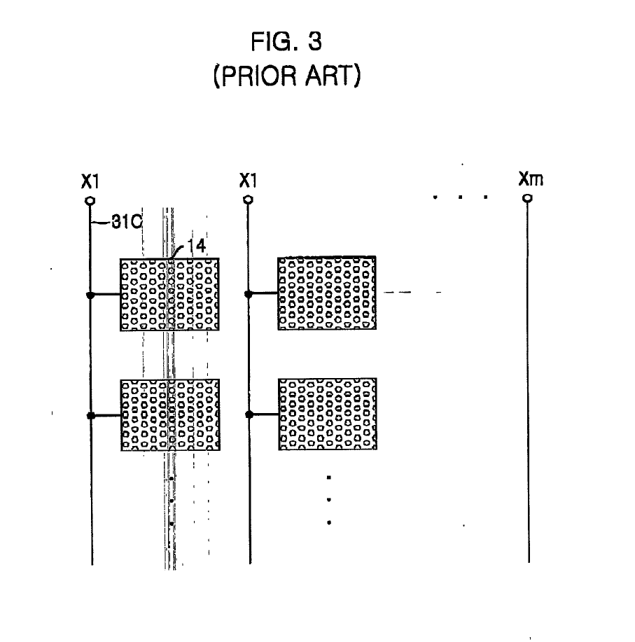

### DETAILED DESCRIPTION OF THE PREFERRED EMBODIMENTS

Hereinafter, preferred embodiments of the present invention will be described in detail with reference to the accompanying drawings.

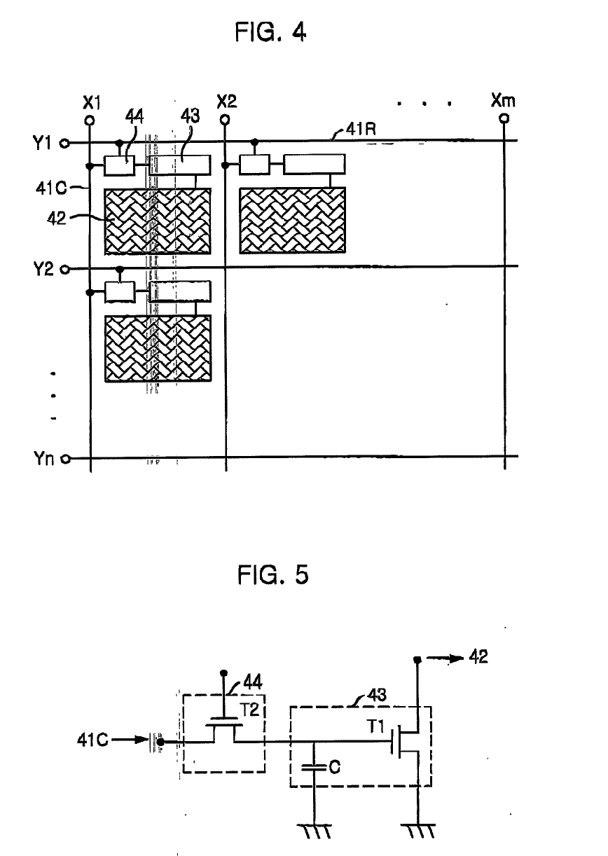

With reference to FIGS. 4 through 10, a lower plate structure of an inventive field emission display device is described in detail, as follows.

In a first preferred embodiment of the present invention, as shown in FIG. 4, the lower plate of the field emission display device includes a row signal bus 41R and a column signal bus 41C based on a belt shape which is made of metal and in which a matrix addressing can be gotten electrically, on an insulation transparent substrate (not shown) like glass. Within respective pixels defined by the row signal bus 41R and the column signal bus 41C, there are a film type field emitter 42 constructed by a thin film or a thick film such as diamond, diamond like carbon and carbon nanotube etc.; a control; device 43 connected to the film type field emitter 42, for controlling field emission current; and an addressing device 44 connected with the control device 43, the row signal bus 41R and the column signal bus 41C, for transferring a scan of a display and a data signal to the control device.

The control device 43 is composed of a switching device for directly controlling the field emission current of the film type field emitter 42, and a memory device for maintaining the data signal of the display

Referring to FIGS. 5 through 8, the construction of the control device 43 and the addressing device 44 is described more in detail, as follows.

As shown in FIGS. 5 to 8, the control device 43 and the addressing device 44 are constructed by a semiconductor switching device, a capacitor and a resistor etc., wherein the semiconductor switching device is composed of a thin-film transistor and a metal-oxide-semiconductor field effect transistor etc.

FIG. 5 is a circuit diagram showing the construction of the control device and the addressing device for a lower plate pixel of the field emission display device in a second preferred embodiment of the invention. In FIG. 5, the control device 43 connected to the film type field emitter 42 includes a first transistor T1 and a capacitor C. Further, the addressing device 44 is constructed by a second transistor T2. A drain of the first transistor T1 is connected to the film type field emitter 42, and its source is grounded, and its gate is connected to first electrode of the capacitor, and second electrode of the capacitor is grounded. A drain of the second transistor T2 constructing the addressing device 44 is connected with the capacitor C of the control device 43 and the gate of the first transistor T1, and a gate of the second transistor T2 is connected to the row signal bus 41R and its source is connected to the column signal bus 41C.

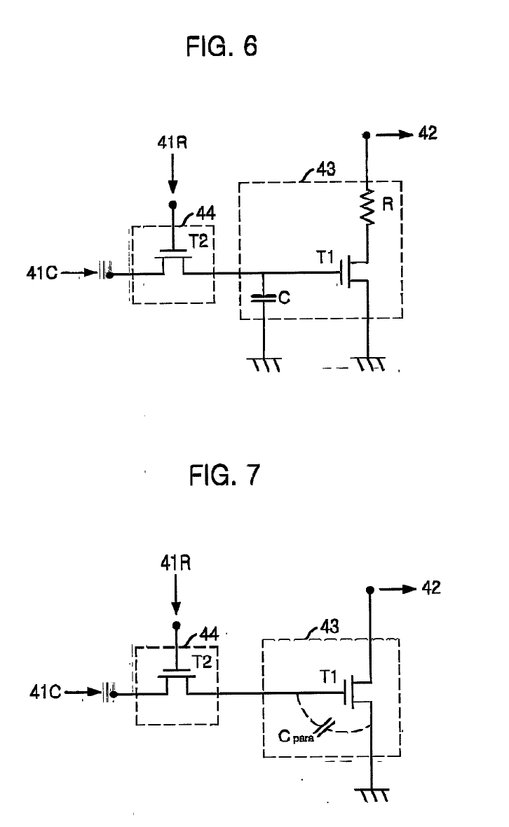

FIG. 6 is a circuit diagram showing the construction of the addressing device and the control device for the lower plate pixel of the field emission display device in a third preferred embodiment of the present invention. In FIG. 6, the control device 43 connected to the film type field emitter 42 is made up of a resistor R, a first transistor T1 and a capacitor C. The addressing device 44 is constructed by a second transistor T2. The construction of FIG. 6 is same as that of FIG. 5, excepting of an insertion of the resistor R between the film type field emitter 42 and a drain of the first transistor T.

FIG. 7 is a circuit diagram showing the construction of the control device and the addressing device for the lower plate pixel of the field emission display device in a fourth embodiment of the present invention. In FIG. 7, the control device 43 connected to the film type field emitter 42 is constructed by a first transistor T1 whose drain is connected to the film type field emitter 42 and which has a constant parasitic capacity Cₚₐᵣₐ between a gate and a source. The addressing device 44 is constructed by a second transistor T2 having a drain connected to the gate of the first transistor T1 provided in the control device 43. The gate of the second transistor T2 constructed as the addressing device 44 is connected to a row signal bus 41R and its source is connected to the column signal bus 41C.

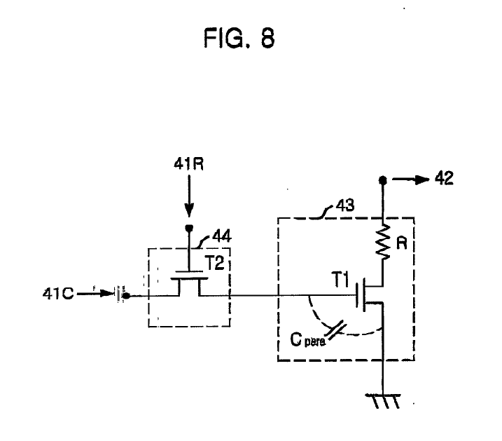

FIG. 8 is a circuit diagram showing the construction of the control device and the addressing device for the lower plate pixel of the field emission display device in a fifth embodiment of the present invention. In FIG. 8, the control device 43 connected to the film type field emitter 42 is constructed by a first transistor T1 whose drain is connected to the film type field emitter 42 and which has a constant parasitic capacity Cₚₐᵣₐ between a gate and a source, and also is constructed by a resistor R. The addressing device 44 is constructed by a second transistor T2. The construction of FIG. 8 is same as FIG 7, excepting of an insertion of the resistor R between the film type field emitter 42 and the drain of the first transistor T.

The parasitic capacity between the gate and the source of the first transistor T1 shown in FIG. 7 and 8 serves as a memory capable of sufficiently maintaining a data signal of the display during one frame of a scan signal.

While, according that high voltage is applied to an anode in order for an electric field emission and an electron acceleration in driving the display, the high voltage is applied to the drain terminal of the transistor. In order to prevent an electrical breakdown owing to an applying of the high voltage, the first transistor T1 of the control device 43 shown in FIGS. 5 through 8 is constructed as a high-voltage transistor which has a high immunity to the electrical breakdown.

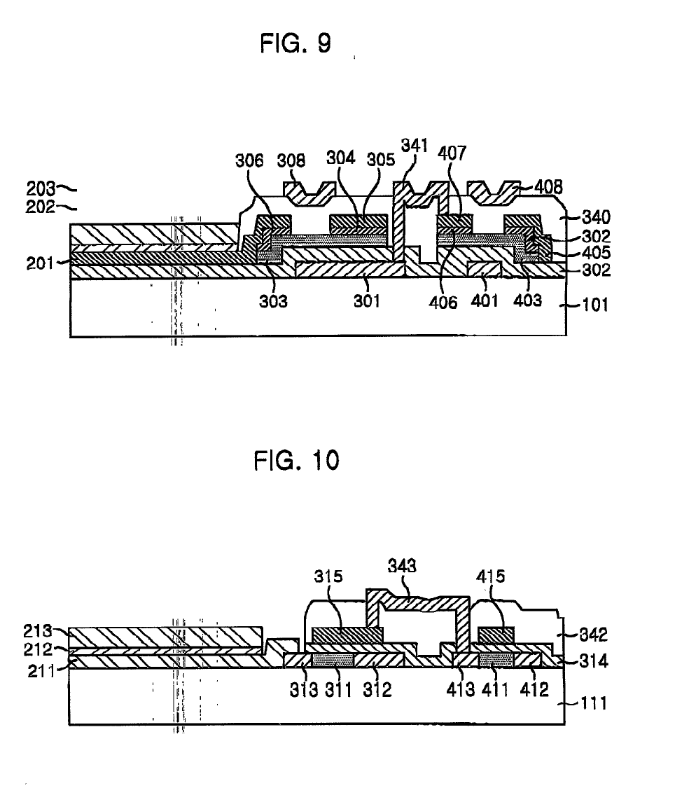

The structure of the lower plate in the field emission display is described by the inventive embodiment referring to FIGS. 9 and 10, as follows.

FIG. 9 is a sectional view showing one pixel of the field emission display lower plate embodied by a sixth embodiment of the invention. This pixel is constructed by control and addressing devices provided as an amorphous silicon thin film transistor based on an inverted stagger type and by a film type field emitter provided as a carbon nanotube.

In the invention, as shown in FIG. 9, a first thin film transistor constructing the control device of the lower plate pixel and a second thin film transistor constructing the addressing device are composed of a gate 301 of the first thin film transistor and a gate 401 of the second thin film transistor, a gate insulation film 302 covering the gates 301, 401 and a glass substrate 101, a first channel 303 and a second channel 403 piled upon each of the gates 301, 401 of the first and second thin film transistors, with an intervention of the gate insulation film 302 between them, and sources 304, 404 and drains 306, 406 separately formed on each of the first channel 303 and the second channel 403.

The source 304 of the first thin film transistor is connected to metal source electrode 305, and the drain 406 and the source 404 of the second thin film transistor are respectively connected to metal drain electrode 407 and source electrode 404. The source 304 of a first amorphous silicon thin film transistor is overlapped with the gate 301 by a relatively wide area so as to have a large parasitic capacitance, and the drain 306 is not overlapped with the gate 301 so as to gain high electrical breakdown voltage. In the inventive embodiment, the gates 301, 401 are formed as metal, and the gate insulation film 302 is formed by a silicon nitride SiNₓ, and the first and second channels 303, 403 are formed by hydrogenated amorphous silicon a-Si:H, and the sources 304, 404 and the drains 306, 406 are formed by n-type amorphous silicon.

Upper parts of such first and second thin film transistors are covered with an inter-layer insulation film 340, and light shaders 308, 408 made of metal are formed on the inter-layer insulation film 340 provided on an upper part of the channels 303, 304 contacting with the inter-layer insulation film 340. The gate 301 of the first thin film transistor and the drain electrode of the second thin film transistor are connected by metal connection electrode 341.

Emitter electrode 201 is formed on the gate insulation film 302 covering the glass substrate 101, and covers the drain 306 of the first thin film transistor so as to be connected electrically, on the emitter electrode 201, a thin film type resistor 202 made of the amorphous silicon or polycrystal silicon thin film is formed and connected thereto. A film type field emitter 203 made of the carbon nanotube is formed on the thin film type resistor 202.

FIG. 10 is a sectional view showing one pixel of the lower plate in the field emission display device in the seventh embodiment of the invention applied to the circuit of FIG. 8, and the pixel is constructed by the control device and the addressing device respectively having the polycrystal silicon thin film transistor and by the film type field emitter provided as the carbon nanotube.

As shown in FIG. 10, in the inventive lower plate pixel, channels 311, 411, sources 312, 412 and drains 313, 413 of each of a first thin film transistor constructing the control device and a second thin film transistor constructing the addressing device are formed on glass substrate 111. A gate insulation film 314 covers areas of the first thin film transistor and the second thin film transistor and the glass substrate 111 provided between them, and exposes partially the drain 313 of the first thin film transistor. Gate electrode 315 of the first thin film transistor is formed on the gate insulation film 314 to be overlapped with the channel area 311 and the source 312. Gate electrode 415 of the second thin film transistor is formed on the gate insulation film 314 to be overlapped with the channel area 411.

The channels 311 and 411 are formed with the polycrystal silicon, and the sources 312, 412 and the drains 313, 413 are doped by an n-type impurity, and the gate insulation film 314 is formed with an oxide film, and the gates 315, 415 are formed with metal or n-type polycrystal silicon.

The source 312 of the first polycrystal silicon thin film transistor is much overlapped with the gate 315 perpendicularly, so as to have the large parasitic capacitance, and the drain 313 is not perpendicularly overlapped with the gate 315 so as to gain the high electrical breakdown voltage.

In such construction, an inter-layer insulation film 342 provided by an oxide film or a nitride film is formed on the first polycrystal silicon thin film transistor and second polycrystal silicon thin film transistor areas, and the gate 315 of the first polycrystal silicon thin film transistors and the drain 413 of the second polycrystal silicon thin film transistor are connected by metal connection electrode 343.

Emitter electrode 211 formed on the glass substrate 111 is in contact with and is electrically connected to the drain 313 of the first thin film transistor which is not covered by the gate insulation film 314. On the emitter electrode 211, a thin film type resistor 212 made of the amorphous silicon or polycrystal silicon etc. is formed. A film type field emitter 213 made of the carbon nanotube etc. is formed on the thin film type resistor 212.

As afore-mentioned, in accordance with the present invention, on a glass substrate provided as a lower plate of a field emission display device, each pixel defined by a signal bus for providing a matrix addressing and such matrix signal bus is constructed by a film type field emitter, a control device for controlling the film type field emitter and an addressing device for transferring scan and data signals of a display to the control device. Then, a representation of the display is driven by the control and addressing device, to thereby largely lessen display matrix driving voltage. According to that, a low voltage driving circuit based on a lower cost can be used instead of a high voltage driving circuit required in the matrix driving of a conventional diode field emission display. Further, a memory function is added to the control device for controlling field emission current, to whereby largely increase a brightness of the display. In addition, since each pixel is electrically isolated by the addressing device on the present invention, a cross-talk of a display signal can be largely restrained. Further, since the field emission current is controlled by the control device connected to the field emitter, a considerable stableness can be obtained, and according to that, the field emission display based on a high fidelity can be manufactured.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A field emission display device having an upper plate and a lower plate vacuum-packaged in parallel, comprising:
a first transparent substrate provided as the upper plate;
transparent electrode formed on the first transparent substrate, for leading an emission and an acceleration of electron;
a phosphor pattern formed on the transparent electrode;
a second transparent substrate provided as the lower plate;
a row signal bus and a column signal bus formed so as to be intersected with each other on the second transparent substrate, said row signal bus and said column signal bus being for defining a pixel;
a film type field emitter positioned within the pixel and confronted with the phosphor pattern;
a control unit connected to the film type field emitter, for controlling field emission current; and
an addressing unit connected with the control unit and the row and column signal buses, for transferring scan and data signals of the display to the control unit.

2. The device of claim 1, wherein said upper plate and said lower plate are vacuum-packaged with a spacer positioned between them, said spacer being provided as a supporter.

3. The device of claim 1, wherein said film type field emitter is constructed by a thin film or a thick film of any one out of diamond, diamond like carbon and carbon nanotube.

4. The device of claim 1, wherein said control unit comprises a semiconductor switching device for controlling the field emission current of the field emitter, and a memory device for maintaining the data signal of the display.

5. The device of claim 3, wherein said control unit comprises a first transistor including,
a gate connected to the memory device;
a drain connected to the field emitter; and
a source grounded.

6. The device of claim 4, wherein said memory device is a capacitor in which first electrode is connected to the gate of the first transistor, and second electrode is grounded.

7. The device of claim 5, wherein said addressing unit is provided as a second transistor including,
a gate connected to the row signal bus;
a drain coupled with the control unit; and
a source coupled with the column signal bus.

8. The device of any one claim of claims 5 through 7, wherein said control unit further comprises a resistor between the drain of the first transistor and the field emitter.

9. The device of claim 8, comprising;
gates of the first transistor and the second transistor respectively formed on the second transparent substrate;
a gate insulation film covering the gates and the second transparent substrate;
first and second channels which are individually formed with the gate insulation film between them and portions of which are respectively overlapped with the gates of the first and second transistors;
a source and a drain separately formed on the first channel and the second channel;
connection electrode for connecting the gate of the first transistor to the drain of the second transistor;
emitter electrode formed on the gate insulation film of the second transparent substrate and connected to the drain of the first transistor;
a resistor formed on the emitter electrode; and
a film type field emitter formed on the resistor.

10. The device of claim 9, wherein said source and gate of said first transistor are overlapped with each other, with the gate insulation film positioned between them, so as to have a parasitic capacitance, and said drain and gate of said first transistor are not overlapped with each other.

11. The device of claim 10, further comprising an inter-layer insulation film which covers areas of the first and second transistors and in which the connection electrode is passed through the inside thereof; and a shading unit overlapped with the channels of the first and second transistors which are respectively in contact with the inter-layer insulation film.

12. The device of claim 8, comprising;
a drain, a channel and a source of each of the first and second transistors formed on said second transparent substrate;
a gate insulation film covering the channel of the first transistor, and the drain, the channel and the source of the second transistor;
a gate of the first transistor formed on the gate insulation film and overlapped with the source and the channel of the first transistors;
a gate of the second transistors formed on the gate insulation film and overlapped with the channel of the second transistor;
connection electrode for connecting the gate of the first transistor to the drain of the second transistor;
emitter electrode connected to the drain of the first transistor;
a resistor formed on the emitter electrode; and
a film type field emitter formed on the resistor.

13. The device of claim 12, further comprising the inter-layer insulation film which covers the areas of the first and second transistors and in which the connection electrode is passed through the inside thereof.

14. The device of claim 8, wherein said first transistor is constructed by a high voltage transistor.

14. The device of claim 8, wherein said first transistor is constructed by a high voltage transistor.

15. The device of claim 9, wherein said first and second channels are individually constructed by an amorphous silicon thin film.

16. The device of claim 12, wherein said first and second channels are respectively constructed by a polycrystal silicon thin film.

17. The device of claim 9, wherein said resistor is constructed by a silicon thin film.

18. The device of claim 12, wherein said source and gate of said first transistor are overlapped with each other, with the gate insulation film positioned between them, so as to have the parasitic capacitance, and said drain and gate of said first transistor are not overlapped with each other.
